(19) United States
(12) Patent Application Publication
(10) Pub. No.: US 2015/0153375 A1
(43) Pub. Date: Jun. 4, 2015

(54) DIGITAL PITCH GAUGE

(71) Applicant: Christian Listl, Tuen Mun NT (CN)

(72) Inventor: Christian Listl, Tuen Mun NT (CN)

(73) Assignee: CEI Conrad Electronic International (HK) Limited, Tsuen Wan, New Territories, Hong Kong (CN)

(21) Appl. No.: 14/406,720

(22) PCT Filed: Aug. 29, 2012
(86) PCT No.: PCT/EP2012/066765

§ 371 Date: Dec. 9, 2014

(30) Foreign Application Priority Data
Jun. 11, 2012 (DE) 20 2012 005 599.2

(51) Int. Cl. G01P 15/00; G01D 9/00; G01C 9/00; A63H 27/00

(52) U.S. Cl. CPC G01P 15/00; A63H 27/12; G01D 9/005; G01C 9/00

(57) ABSTRACT

A measurement device for measuring and adjusting at least one control element of a model helicopter includes an electronic measurement unit (2), and a fastening unit (7) which is or can be connected rigidly to the electronic measurement unit (2) and which is to be mounted on the control element to be measured. To make available a measurement device with which other control elements of a model helicopter can be measured and adjusted, the measurement device (20) is provided for measuring and adjusting the tilt of a swash plate of the model helicopter. The fastening unit (7) can be placed flat at least in some areas on the top and/or the bottom of the swash plate.

The invention relates to a measuring device for the purpose of measuring and adjusting at least one control element of a model helicopter, having the further features of the preamble of claim 1.

Corresponding measuring devices are also called pitch gauges. A pitch gauge serves the purpose of verifying, measuring, and adjusting the approach angle (also called the pitch value or pitch angle) of the rotor blades of a model helicopter. To make the rotor system as a whole harmonious, it is necessary to precisely adjust the rotor blade angle of approach. There are digital pitch gauges which display the angle of approach of the rotor blades digitally. Such a digital pitch gauge substantially comprises an attachment device which is pushed over the tip of the rotor blade being adjusted, and is then attached. An electronic measurement unit is rigidly connected and/or can be connected to the attachment device, such that the inclination of the attachment device, and therefore of the rotor blade, can be read directly on the measurement unit.

The electronic measurement unit has an acceleration sensor (also called an acceleration measuring device or accelerometer) by means of which the inclination is measured.

The problem addressed by the present invention is that of providing a measuring device in the class by means of which it is possible to measure and adjust other control elements of a model helicopter.

This problem is addressed by the entire teaching of claims 1, 7, and 12. Advantageous implementations of the invention are found in the dependent claims.

The problem stated above is addressed, on the one hand, by the measuring device being provided for the purpose of measuring and adjusting the inclination of a swash plate of the model helicopter, wherein the attachment device can be placed flat, at least sectionally, on the upper- and/or underside of the swash plate. The measuring device makes it possible to adjust the precise horizontal orientation of the swash plate in its stationary position. If the swash plate is slightly tilted, this is displayed on the electronic measurement unit. In this case, both the roll angle and the pitch angle—that is, the inclination of two axes at the same time—are measured and displayed, whereby it is therefore possible to precisely adjust the position and/or horizontal orientation of the swash plate in a simple manner, without any further auxiliary means.

The attachment device preferably has two contact elements, wherein the distance between the same can be changed, and wherein the same can be placed on the upper and lower sides of the swash plate and fixed thereon. As a result of the contact elements with their modifiable spacing, the attachment device is flexible, and can therefore be precisely adapted to different swash plate heights.

The contact elements can be arranged parallel to each other, and therefore also placed on the upper and lower sides of the swash plates, said sides oriented parallel to each other, in an ideal manner.

The contact elements can advantageously be attached to the swash plate by means of a nut arranged on a threaded spindle, such that they are pressed on the swash plate on the upper and lower sides thereof. The threaded spindle in this case connects the contact elements to each other, which are additionally, advantageously connected on the lateral edges thereof by means of supports which can slide toward each other. The contact elements are accordingly placed on the upper and lower sides of the swash plate and then gently pressed onto the swash plate by means of rotating the nut on the threaded spindle, such that the position of the entire attachment device can be stabilized during the measurement and adjustment.

At least one, and particularly both contact elements can have a lateral recess for placement on the primary rotor shaft. The contact elements therefore lie on the swash plate both on the upper and the lower sides thereof, and partially encompass the primary rotor shaft. As a result, the swash plate is also covered and/or clamped, on the upper and lower sides thereof, over a relatively large area, by the contact elements. The attachment device is consequently positioned precisely and securely, such that it is possible to carry out a precise adjustment and measurement of the inclination of the swash plate.

It is advantageously possible to include different contact elements with different sizes of lateral recesses, the same matched, or at least substantially matched, to different sizes of primary rotor shafts. The suitable contact element can be selected according to the diameter of the primary rotor shaft, and arranged on the measuring device.

The attachment device has a holding region with a contact surface for the arrangement of the measurement unit, wherein the contact surface of the holding region can be arranged perpendicular to the plane of the contact elements. The right-angle arrangement of the measurement unit and the attachment device thereby enables a precise measurement of the inclination, both of the roll angle and the pitch angle of the swash plate.

In a further embodiment variant according to the invention, the measuring device is used for the purpose of measuring and adjusting the pitch angle of the tail rotor blades of the model helicopter. The attachment device to which the measurement unit is connected or can be rigidly connected is attached to the tail rotor blade so that it is possible to measure and adjust the pitch angle thereof (in this case, this is also called the ‘roll angle’). The measurement unit in this case is arranged at a right angle to the attachment device so that it is possible to precisely measure the inclination of the tail rotor blade.

The attachment device can advantageously have at least one clamping element or a clamp device for the purpose of attachment to a tail rotor blade. For this purpose, a holder element can be included, the same being able to slide in a longitudinal opening, by means of which a tail rotor blade can be clamped by the edges and/or by the width thereof. Because the holder element can slide, it is possible to clamp tail rotor blades which have different widths.

The attachment device can have a holding region with a contact surface for the arrangement of the measurement unit, wherein the contact surface is arranged perpendicular to the clamp device. As a result, the measurement unit is also arranged at a right angle to the attachment device.

In a further embodiment of the measuring device, the same serves the purpose of measuring and adjusting primary rotor blades of the model helicopter, wherein the measuring device has an attachment element for a direct or indirect arrangement on a primary rotor blade holder of the model helicopter. In this way, it is possible carry out the measurement and adjustment of the pitch angle of the primary rotor blades without the need to arrange the measuring device and/or the attachment device on the primary rotor blade itself. The measurement is carried out by arranging the measurement unit on a corresponding blade holder of the primary rotor, because the inclination of the blade holder corresponds to the inclination of the rotor blade which is then attached to the blade holder. In particular, the measuring device can be attached directly to the screw head of the screw of the primary rotor blade.

A magnet can advantageously be included as the attachment element, the same being able to be attached on the screw head of the screw of the blade holder by means of magnetic attraction.

A threaded nut can also advantageously be included as the attachment element, arranged on or in the measurement unit, wherein the screw of the primary rotor blade holder can be screwed into the threaded nut. For this purpose, the screw of the blade holder can be passed through the blade holder from below or from above, and then screwed into the threaded nut. A different counter piece with an inner threading can be included in place of the threaded nut, wherein the screw can be screwed into the same.

The attachment element can be included on the upper or lower edge region of the measurement unit, such that the measurement unit is oriented substantially horizontal during the measurement procedure. If the attachment element is included on the upper edge region of the measurement unit, the measurement unit is then upside down and the display rotates 180° so that it can still be easily read by the user.

As an alternative, the measurement unit itself and/or the housing thereof can be used for the angle or inclination measurement. For this purpose, the measurement unit can be placed directly on, by way of example, the primary rotor blade holder, by the lateral surface or edge surface of said measurement unit in order to measure its inclination. The side opposite the attachment element—that is, opposite the threaded nut or the magnet—which has a flat surface can be advantageously selected for this purpose.

It is particularly advantageous that the various different measurements and adjustments of different control elements of a model helicopter can be undertaken by means of the same measurement unit and the various attachment elements described above. Each contact surface in this case can have the same design for the arrangement of the measurement unit, such that the measurement unit can always be attached to the attachment device in the same manner. In this way, by way of example, magnets can be used for the arrangement of the measurement unit on the attachment device, each accordingly or identically positioned.

In addition, the measurement unit can also be used on an attachment device for the measurement and adjustment of the pitch angle of the primary rotor blades, in the manner known to date, wherein the rotor blade is placed in the attachment device—that is, the blade holder—and clamped.

The measurement unit can advantageously have a direction finding element for optical direction finding, so that it is possible to compare the position of the measurement unit with the primary rotor shaft and/or the rotor shaft of the model helicopter. The user can thereby visually check whether the vertical axis of the measurement unit is parallel to the primary shaft of the helicopter. For this purpose, the measurement unit can be attached to one of the primary rotor blades by means of the corresponding attachment device. It is therefore possible to check the overall position of the rotor shaft and the rotor blades.

The direction finding element can either match the vertical or horizontal axis of the measurement unit. It can be designed with a pin shape or needle shape to enable good visual direction finding with respect to the primary shaft.

The direction finding element can be attached, or able to attach, on an edge of the measurement unit. By way of example, it can be attached by means of a screw or a magnet, and easily removed again when not in use.

The measurement unit can advantageously save certain adjustment variables of the control elements. As such, it is possible that certain pitch, roll and/or incidence angles are saved after the measuring device is switched off. When the control elements and/or the different angles of inclination are once more adjusted, it is possible to use the previously saved data and carry out the same adjustment once more.

The measurement unit can advantageously comprise a signaling device which generates a signal when a certain variable is reached. The signaling device can be an optical signaling device which illuminates when a certain angle setting has been reached. An acoustic signaling device can also be included which generates an acoustic signal when a certain (desired) angle setting is reached.

The measuring device and/or the measurement unit contains an acceleration sensor to make it possible to measure the inclination using the acceleration due to gravity. Miniaturized sensors in the form of MEMS (microelectric mechanical system) accelerators are advantageously used.

The invention is explained below with reference to advantageous embodiments in the drawings, wherein:

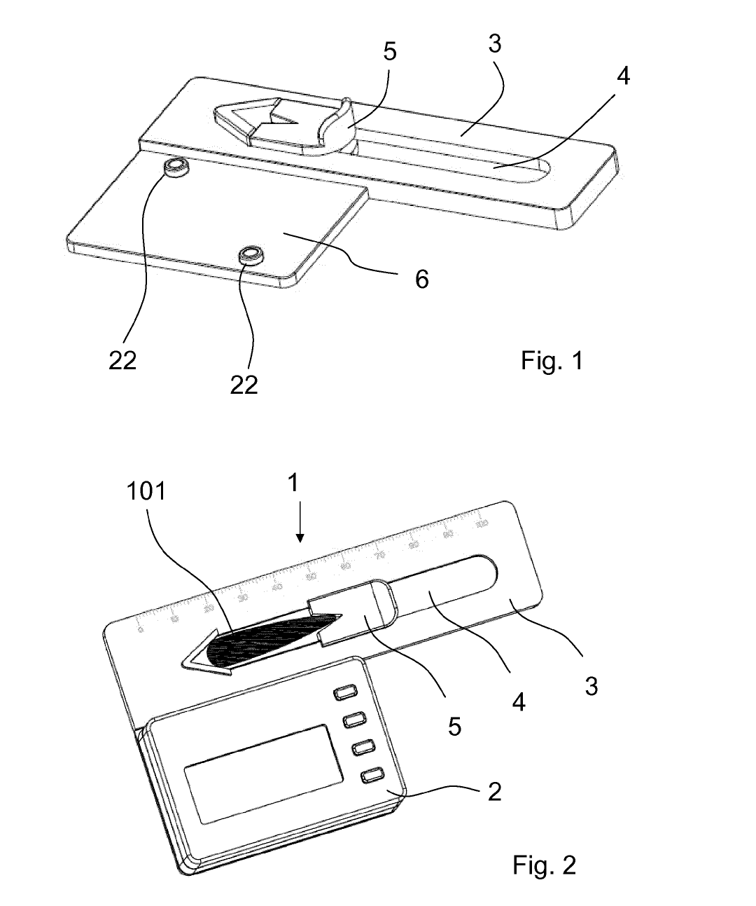

FIG. 1 shows a perspective illustration of the attachment device of a measuring device for the purpose of measuring the angle of approach of the primary rotor blade of a model helicopter;

FIG. 2 shows a perspective illustration of the measuring device for the purpose of measuring the angle of approach of the primary rotor blade of a model helicopter;

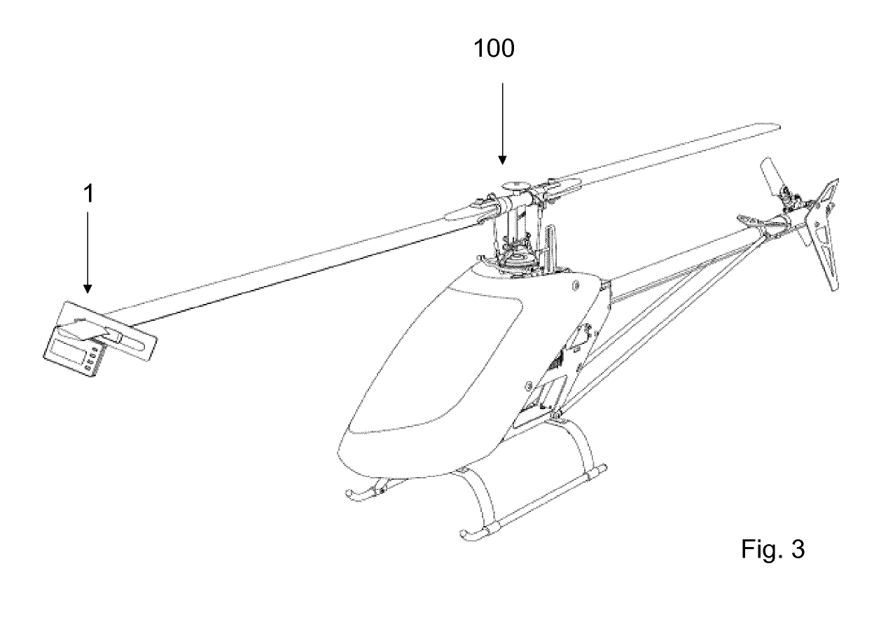

FIG. 3 shows a perspective illustration of a model helicopter with a measuring device arranged thereon for the purpose of measuring the angle of approach of the primary rotor blade;

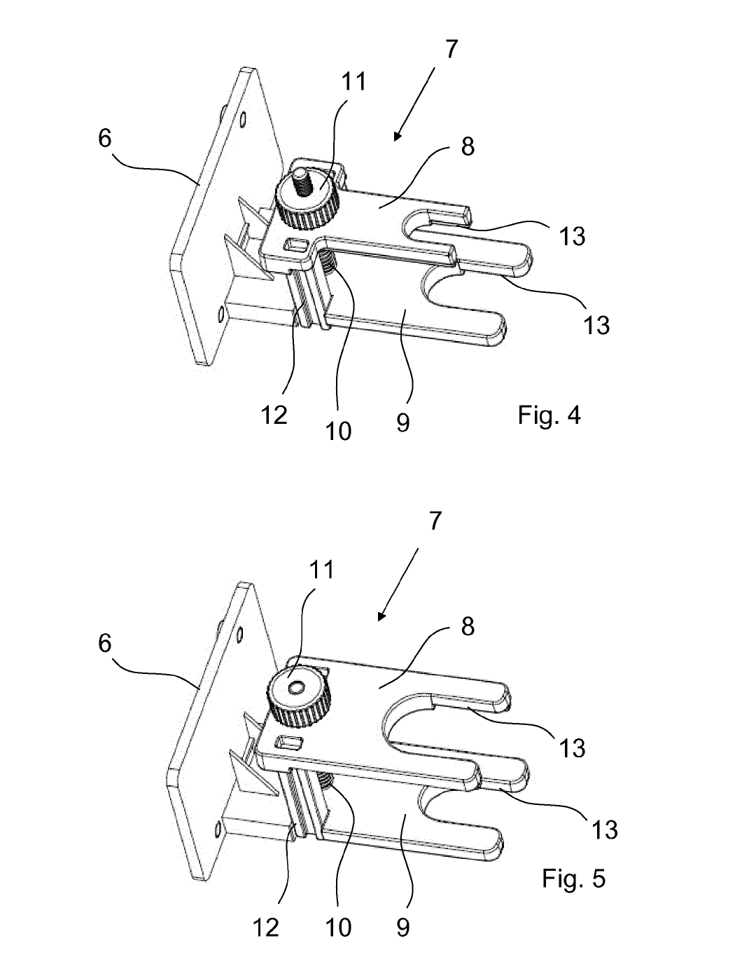

FIG. 4 shows a perspective illustration of an attachment device of a measuring device for the purpose of measuring the inclination of the swash plate of a model helicopter;

FIG. 5 shows a perspective illustration of an attachment device of a measuring device for the purpose of measuring the inclination of the swash plate of a model helicopter, with another contact element than that in the embodiment variant in FIG. 4;

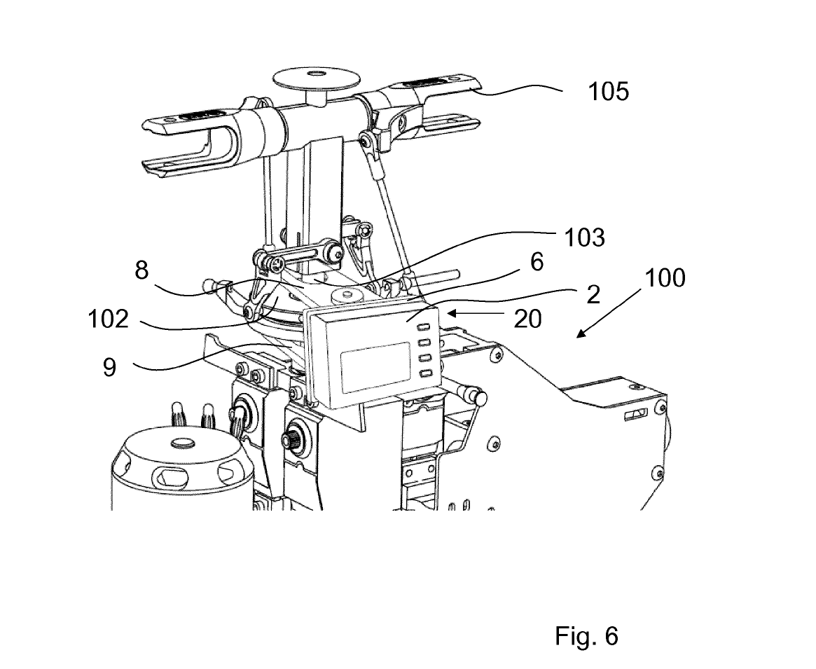

FIG. 6 shows a perspective illustration of the upper region of a model helicopter, with a measuring device arranged thereon for the measurement and adjustment of the inclination of the swash plate;

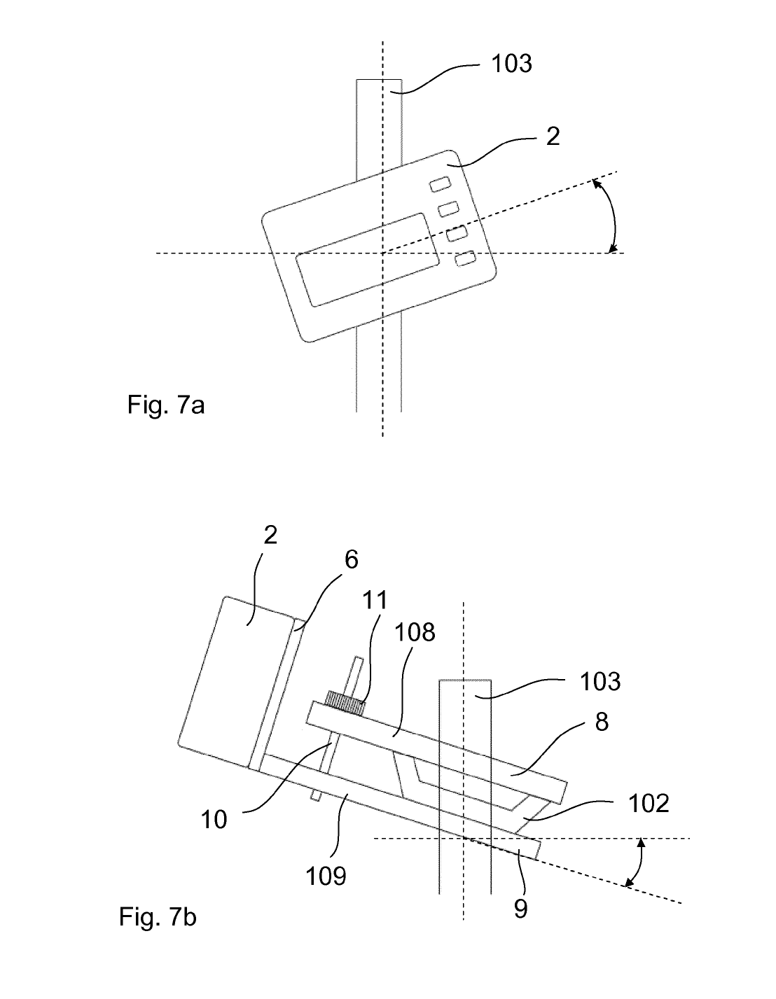

FIG. 7a shows a principle illustration of the measurement of the roll angle by means of a measuring device for the measurement and adjustment of the inclination of a swash plate;

FIG. 7b shows a principle illustration of the measurement of the pitch angle by means of a measuring device for the measurement and adjustment of the inclination of a swash plate;

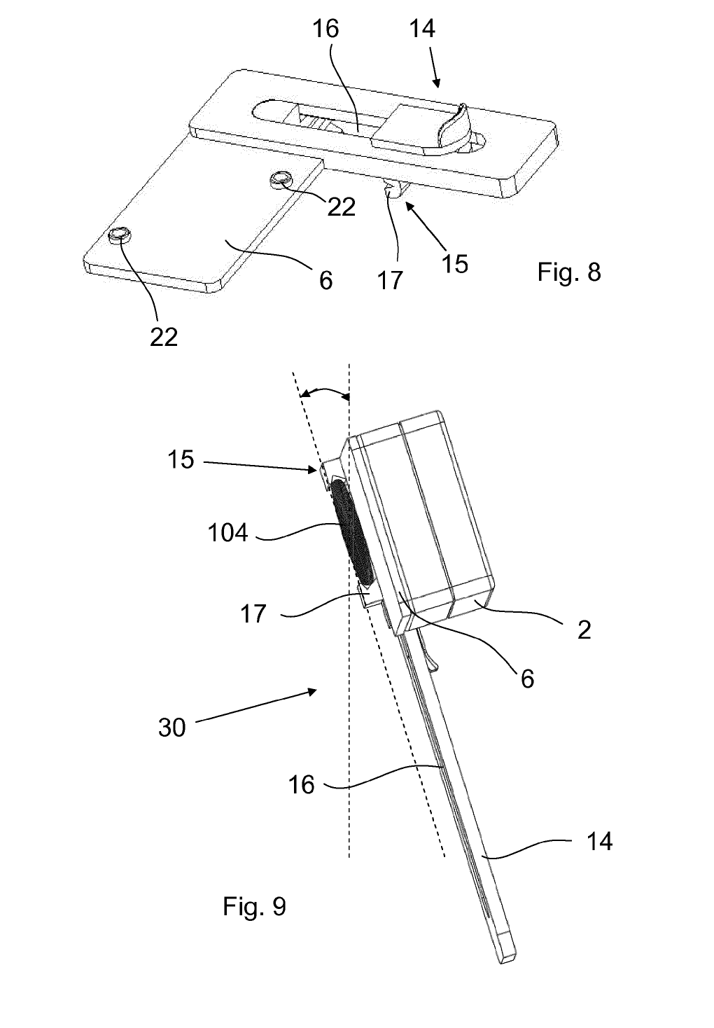

FIG. 8 shows a perspective illustration of an attachment device of a measuring device for the purpose of measuring and adjusting the pitch angle (=the angle of approach) of the tail rotor blade of the model helicopter;

FIG. 9 shows a perspective illustration of the measuring device for the purpose of measuring and adjusting the pitch angle of the tail rotor blade of a model helicopter;

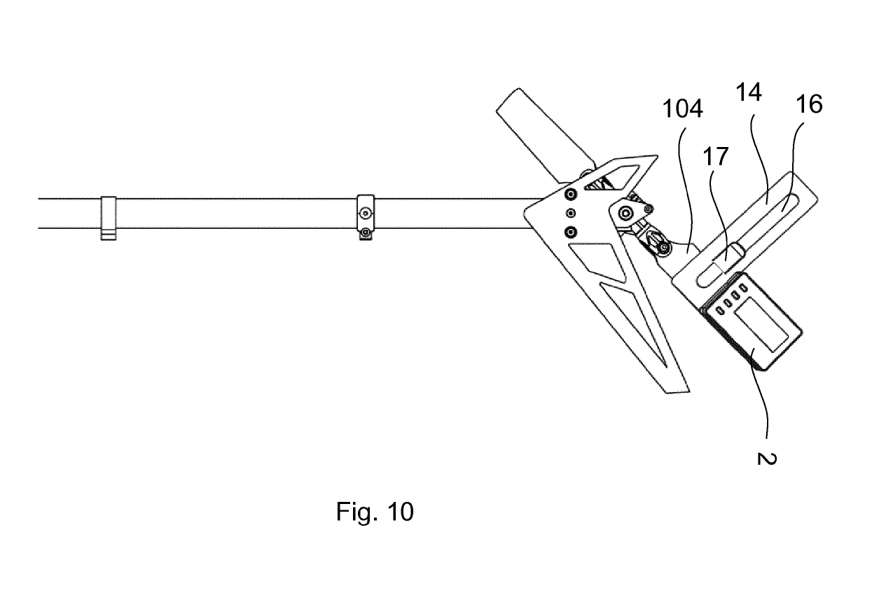

FIG. 10 shows a perspective illustration of the rear region of a model helicopter with a measuring device arranged on the tail rotor blade for the purpose of measuring the pitch angle;

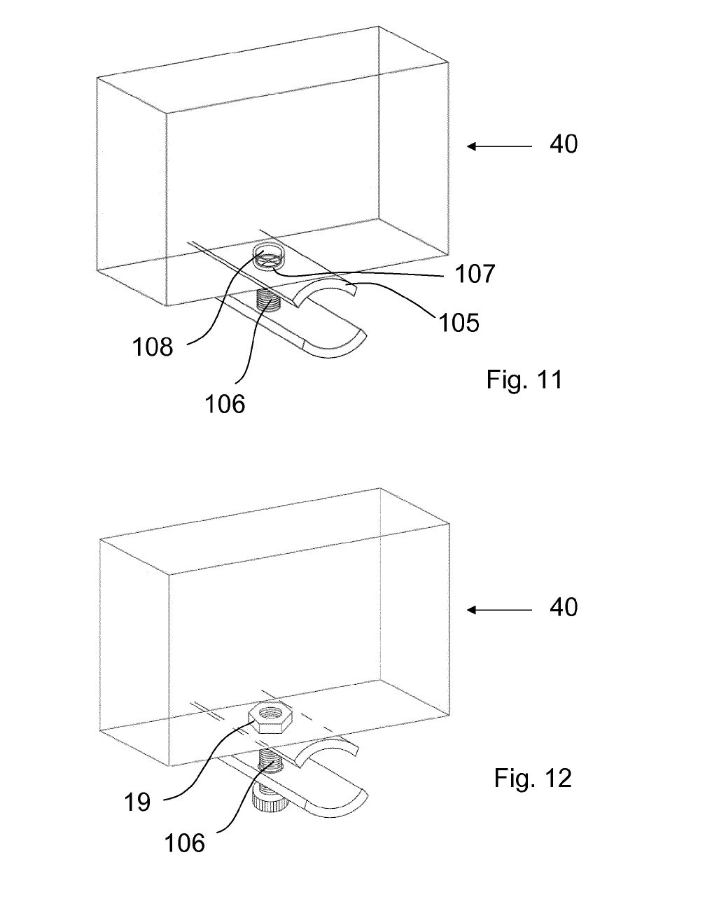

FIG. 11 shows a perspective principle illustration of the arrangement of a measuring device on a primary rotor blade holder by means of a magnet;

FIG. 12 shows a perspective principle illustration of the arrangement of a measuring device on a primary rotor blade holder by means of a threaded attachment;

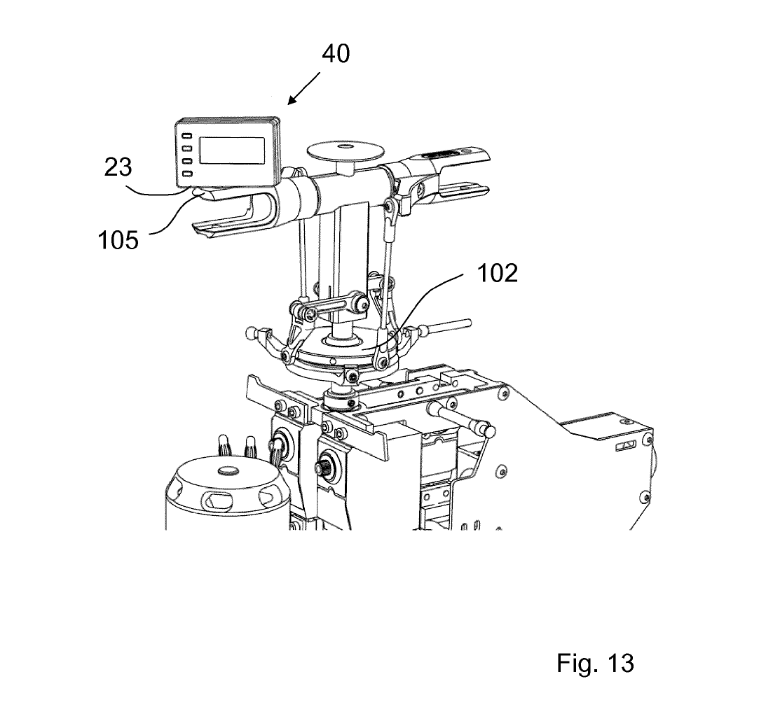

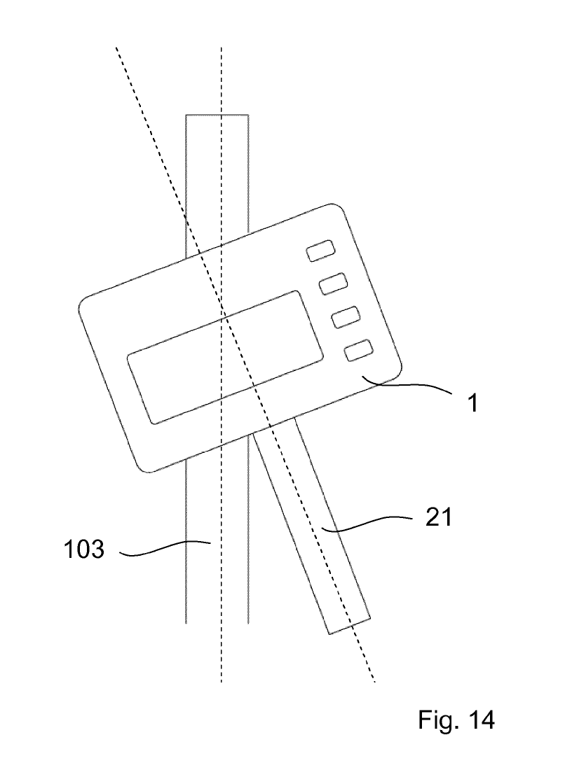

FIG. 13 shows a perspective illustration of the upper region of a model helicopter, with a measuring device arranged on the primary rotor blade holder;

FIG. 14 shows a principle illustration of a measuring device with a direction finding element; and

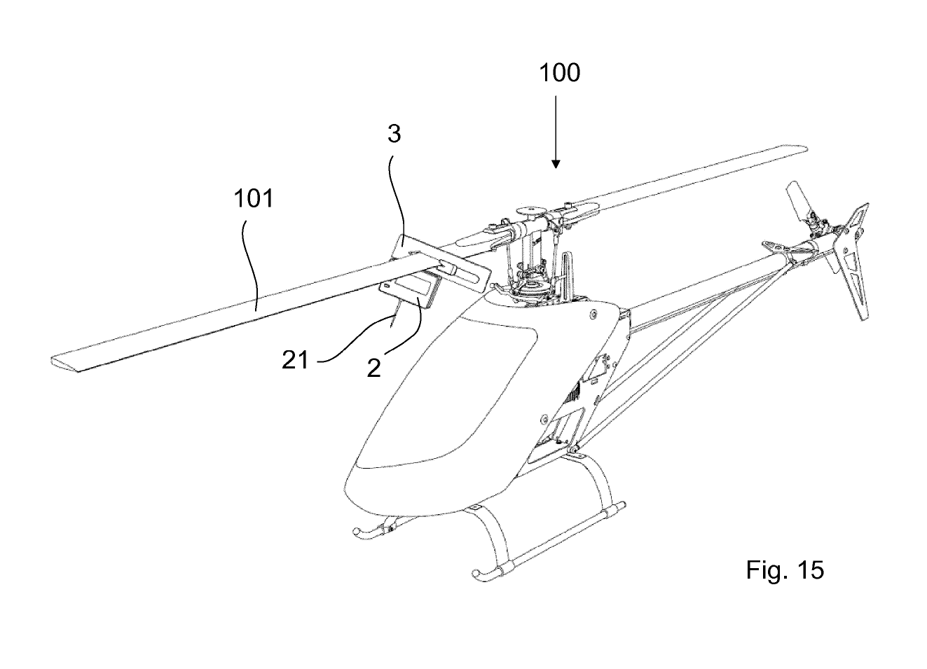

FIG. 15 shows a perspective illustration of a model helicopter with a measuring device, arranged on the primary rotor blade, having a direction finding element.

A measuring device for the purpose of measuring and adjusting a primary rotor blade of a model helicopter is known, as illustrated in FIGS. 1 to 3. This measuring device overall is indicated by the reference number 1, and is also termed a digital pitch gauge. It comprises an electronic measurement unit 2 and an attachment device 3 which can be rigidly connected to the electronic measurement unit 2, and which is attached to the primary rotor blade 101 of a model helicopter 100 in the illustration in FIG. 3. For this purpose, the attachment device 3 has a longitudinal opening 4 with a holder element 5 which is able to slide therein, such that the primary rotor blade 101 can be guided through the longitudinal opening 4 and clamped securely into position by means of the holder element 5. The electronic measurement unit 2 is fixed on a contact surface 6 by magnets 22. The electronic measurement unit 2 includes an acceleration sensor by means of which the inclination of the measurement unit 2, and therefore also the inclination of the primary rotor blade 101, can be measured and displayed. If the angle of approach of the primary rotor blade 101 changes, this is accordingly displayed on the electronic measurement unit 2. In this way, the angle of approach (also called the pitch angle) of the primary rotor blade 101 can be precisely set.

A measuring device 20 is provided according to the invention for the measurement and adjustment of a swash plate 102 of the model helicopter 100, wherein the attachment device 7 included for this purpose (see FIGS. 4 and 5) can be placed at least partially flat against the swash plate 102 on the upper and lower sides thereof. The arrangement of the measuring device 20 on the swash plate 102 is illustrated in FIG. 6. The inclination of the swash plate 102 can be precisely measured by means of this measuring device 20, and adjusted as desired. According to the principle illustration in FIG. 7a, it is possible, on the one hand, to measure the roll angle—that is, the inclination—of the swash plate 102 with respect to the primary shaft 103. On the other hand, according to FIG. 7b, the so-called pitch angle—that is, the inclination of the primary shaft 103 tilted forward or backward—can be measured. The measurement can be carried out in both directions in only one step, because the attachment device 7, with its contact elements 8, 9, lies flat against the swash plate 102 on both the upper and lower sides thereof. Both the roll angle and the pitch angle are displayed on the electronic measurement unit 2.

The spacing between the contact elements 8, 9 can be changed. In this way, they can be precisely placed flatly against swash plates with different thicknesses.

The contact elements 8, 9 are also arranged parallel to each other in order to ensure the flat contact with the swash plate 102, as well as the correct orientation thereof.

The contact elements 8, 9 can be pressed against the swash plate 102 by means of a nut 11 arranged on a threaded spindle 10. In this way, it is possible to ensure both the flat contact of the contact elements 8, 9 against the swash plate 102 and the secure attachment on the same. In addition to the threaded spindle 10, the contact elements 8, 9 are connected via lateral supports 12 in a manner in which it is possible to change the spacing between the same. These supports 12 additionally provide a parallel orientation of the contact elements 8, 9 to each other. The supports 12 are attached on the lower contact element 9, and engage laterally in the upper contact element 8 in a manner allowing sliding.

The contact elements 8, 9 each have lateral recesses 13 for placement on the primary shaft and/or the rotor shaft 103. As a result, they can also be secured in position, and the flat contact with the swash plate 102 is additionally facilitated. The recesses 13 in FIGS. 4 and 5 differ in their sizes, such that each contact element 8 can be placed on any differently sized primary shaft.

The attachment device 3 also has a holding region with a contact surface 6 for the arrangement of the measurement unit 2, wherein the contact surface 6 of the holding region 6 is arranged perpendicular to the plane of the contact elements 8, 9. Due to this perpendicular arrangement of the contact surface 6 and contact elements 8, 9 with respect to each other, it is possible to measure the inclination of the swash plate 102 in both directions.

A further measuring device enables the measurement and adjustment of the pitch angle and/or the angle of approach of the tail rotor blades 104 of a model helicopter 100. Reference is hereby made to FIGS. 8 through 10. The attachment device 14 shown in FIG. 8 can be attached to a tail rotor blade 104—as shown in FIGS. 9 and 10. A holding region is included on the attachment device 14, with a contact surface 6 for the attachment of the electronic measurement unit 2. The pitch angle of the tail rotor blades 104 can be easily measured by means of this measuring device 30, and the measured value can be read on the electronic measurement unit 2.

The attachment device 14 includes a clamp device 15 for attachment on the tail rotor blade 104. The clamp device 15 clamps the tail rotor blade 104 on the edge thereof, as is shown in FIG. 9.

The clamp device 15 has a holder element 17 which can slide in a longitudinal opening 16, such that tail rotor blades 104 of different widths can be clamped in the clamp device and securely attached therein.

In addition, the attachment device 14 has a holding region with a contact surface 6 for the arrangement of the measurement unit 2, wherein the contact surface 6 is arranged perpendicular to the clamp device 15. It is possible, due to the perpendicular arrangement of the measurement unit 2 and the clamp device 15 with respect to each other, to measure and display the inclination and/or the angle of approach of the tail rotor blade 104 on the electronic measurement unit 2 via the rigid attachment to the same.

In a further measuring device 40, the measurement and adjustment of primary rotor blades 101 of a model helicopter 100 are carried out, wherein the electronic measurement unit 2 has an attachment element for direct or indirect arrangement on a primary rotor blade holder 105 of the model helicopter 100 (see FIGS. 11 to 13). As a result, it is possible to carry out the angle of approach [sic] of the primary rotor blades 101 without the same actually being attached on the helicopter and/or on the primary rotor blade holder 105. The inclination of the primary rotor blade holder 105 and/or the angle of approach thereof is directly transmitted to the primary rotor blade 101 attached later, such that the adjustment is also possible directly on the primary rotor blade holder 105.

A magnet 18 is included as the attachment element in the embodiment variant in FIG. 11, attached to the screw head 107 of the screw 106 of the primary rotor blade holder 105 by magnetic attraction. The magnet 18 is integrated into the housing of the measuring device 40 and sits flush with the housing surface.

In the embodiment variant in FIG. 12, a threaded nut 19 is included as the attachment element, and the screw 106, inserted from below into the primary rotor blade holder 105, engages in the same. The threaded nut 19 is integrated into the housing of the measuring device 40, and therefore does not project outward, causing an interference.

Each attachment element is arranged on the upper edge or edge region of the measurement unit 2.

FIG. 13, in contrast, shows the arrangement of the measuring device 40 on a primary rotor blade holder 105 during the measurement, wherein the inclination itself is measured by means of the measurement unit 2. The measurement unit 2 in this case is placed directly on the primary rotor blade holder 105 by its lateral surface 23. The lateral surface 23 therefore simultaneously serves the purpose of an attachment element. The measurement unit 2 in this case is upside down. The display automatically rotates 180°, such that the measured value can still be read easily.

The electronic measurement unit 2 can be used for the different measurements of the swash plate, tail rotor blades, and primary rotor blades as described above. The measurement unit 2 in this case need only be arranged on the specific, suitable attachment device, which in turn is attached to the control element being measured and adjusted. Accordingly, only one electronic measurement unit 2, and various attachment devices or attachment elements are necessary to carry out all measurements. These advantageously form a cohesive set which is either sold as a unit, or can be accordingly added to.

In addition, the measuring device 2 has a direction finding element 21 for visual direction finding. The orientation of the primary shaft 103 with respect to the measuring device 1, 20, 30, or 40 can thereby be easily checked visually. The perpendicular orientation of the primary shaft 103 can therefore be checked and adjusted.

The direction finding element 21 matches the vertical axis of the measurement unit, and has a pin-shaped or needle-shaped design such that the direction of the primary shaft 103 can be taken as precisely as possible.

The direction finding element 21 is attached on the lower side of the measurement unit 2. As can be seen in FIG. 15, during the adjustment of the primary rotor blades 101, the visual direction finding, with respect to the primary shaft 103, can be carried out at the same time by means of the direction finding element 21.

The measurement unit 2 also makes it possible to save certain adjustment variables of the contact elements. As such, certain angles of approach of the primary or tail rotor blades, by way of example, which have proven particularly favorable in flight, can be saved and adjusted in a simple manner. In order to simplify this adjustment option, the measurement unit 2 has a signaling device which generates a visual or acoustic signal when a certain variable is reached.

### LIST OF REFERENCE NUMBERS

1) measuring device
2) electronic measurement unit
3) attachment device
4) longitudinal opening
5) holder element
6) contact surface
7) attachment device
8) contact element
9) contact element
10) threaded spindle
11) nut
12) support
13) recess
14) attachment device
15) clamp device
16) longitudinal opening
17) holder element
18) magnet
19) threaded nut
20) measuring device
21) direction finding element
22) magnet
23) lateral surface
30) measuring device
40) measuring device
100) model helicopter
101) primary rotor blade
102) swash plate
103) primary shaft
104) tail rotor blade
105) primary rotor blade holder
106) screw
107) screw head

1. A measuring device for measuring and adjusting at least one control element of a model helicopter, comprising:
an electronic measurement unit; and
an attachment device which is connected to, or rigidly fixed to, the electronic measurement unit, for being attached to the control element being measured;
wherein the measuring device is configured for measuring and adjusting the inclination of a swash plate of the model helicopter, wherein the attachment device is configured for being placed flat, at least sectionally, on the upper and/or lower side of the swash plate.

2. A measuring device according to claim 1,
wherein the attachment device has two contact elements with a variable spacing from each other.

3. A measuring device according to claim 2,
wherein the contact elements are arranged parallel to each other.

4. A measuring device according to claim 2,
wherein the contact elements are configured for being pressed against the swash plate by a nut which is arranged on a threaded spindle.

5. A measuring device according to claim 2,
wherein at least one contact element has a lateral recess for being placed on a primary rotor shaft.

6. A measuring device according to claim 1,
wherein the attachment device has a holding region with a contact surface for arranging the measurement unit, wherein the contact surface of the holding region is arranged perpendicular to a plane of the contact elements.

7. A measuring device for measuring and adjusting at least one control element of a model helicopter, comprising:
an electronic measurement unit; and
an attachment device which is connected to, or can be rigidly fixed to, the electronic measurement unit, the electronic measurement unit being attached to the control element being measured, according to claim 1;
wherein the measuring device is included for measuring and adjusting a pitch angle of tail rotor blades of the model helicopter, wherein the attachment device is attached to the tail rotor blade.

8. A measuring device according to claim 7,
wherein the attachment device has at least one clamp device for attachment to a tail rotor blade.

9. A measuring device according to claim 8,
wherein the clamp device clamps the tail rotor blade laterally.

10. A measuring device according to claim 8,
wherein the clamp device has a holder element which is slidable in a longitudinal opening.

11. A measuring device according to claim 7,
wherein the attachment device has a holding region with a contact surface for arranging the measurement unit, wherein the contact surface is arranged perpendicular to a plane of the clamp device.

12. A measuring device for measuring and adjusting at least one control element of a model helicopter, comprising:
an electronic measurement unit; and
an attachment device which is connected to, or rigidly fixed to, the electronic measurement unit, the electronic measurement unit being attached to the control element being measured, according to claim 1;
wherein the measuring device is included for measuring and adjusting primary rotor blades of the model helicopter, wherein the electronic measurement unit has an attachment element for direct or indirect arrangement on a primary rotor blade holder of the model helicopter.

13. A measuring device according to claim 12,
wherein a magnet is included as the attachment element.

14. A measuring device according to claim 12,
wherein a threaded nut is included as the attachment element.

15. A measuring device according to claim 12,
wherein the attachment element is included on the upper edge region or lower edge region of the measurement unit.

16. A measuring device according to claim 1,
wherein the measurement unit has a direction finding element for optical direction finding.

17. A measuring device according to claim 16,
wherein the direction finding element agrees with a vertical axis or a horizontal axis of the measurement unit.

18. A measuring device according to claim 16,
wherein the direction finding element has a pin-shaped or needle-shaped design.

19. A measuring device according to claim 16,
wherein the direction finding element is attached, or can be attached, on a lateral surface of the measurement unit.

20. A measuring device according to claim 1,
wherein the measurement unit saves selected adjustment variables of the control elements.

21. A measuring device according to claim 1,
wherein the measurement unit has a signaling device which generates a signal when a selected variable is reached.
